(19) United States
(12) Patent Application Publication
(10) Pub. No.: US 2013/0054631 A1
(43) Pub. Date: Feb. 28, 2013

(54) ADDING SOCIAL NETWORK DATA TO SEARCH SUGGESTIONS

(71) Applicants: TABREEZ GOVANI, BELLEVUE, WA (US); ASHWIN SATYANARAYANA, SAMMAMISH, WA (US); KEVIN L. HAAS, LOS GATOS, CA (US); YI-AN LIN, SUNNYVALE, CA (US); SAMEER INDARAPU, MOUNTAIN VIEW, CA (US); SAMIR SHIRAZ PRADHAN, BELLEVUE, WA (US)

(72) Inventors: TABREEZ GOVANI, BELLEVUE, WA (US); ASHWIN SATYANARAYANA, SAMMAMISH, WA (US); KEVIN L. HAAS, LOS GATOS, CA (US); YI-AN LIN, SUNNYVALE, CA (US); SAMEER INDARAPU, MOUNTAIN VIEW, CA (US); SAMIR SHIRAZ PRADHAN, BELLEVUE, WA (US)

(73) Assignee: MICROSOFT CORPORATION, REDMOND, WA (US)

(21) Appl. No.: 13/221,026

(22) Filed: Aug. 30, 2011

(51) Int. Cl. G06F 17/30

(52) U.S. Cl. 707/767; 707/E17.137

(57) ABSTRACT

Methods, computer systems and computer-readable media for adding social network data to search suggestions are provided. At least a portion of a search query is received, and a set of suggested search queries is determined for the at least a portion of the search query. A first suggested search query in the set of suggested search queries is determined to be associated with a person or entity. A social data store is accessed; the social data store includes social network data. It is determined that the person or entity is associated with a set of social network data in the social data store, and the set of social network data in association with the first suggested search query is provided to a search engine page.

### BACKGROUND

Typically, when a user begins to enter a portion of a search query, a list of suggested queries is provided. However, these suggested queries often lack associated data that may aid the user in selecting an appropriate suggested query. For example, users have begun to rely on social network data to help guide their decisions. If one or more people in the user's online social network have “liked” an object, such as a restaurant, the user may be more likely to select that restaurant from a list of suggested restaurants. This type of social network data is generally not provided with the list of suggested queries.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable storage media for, among other things, leveraging the wealth of social network data that exists to help disambiguate search queries. In brief and at a high level, a portion of a search query is received from a user. A list of suggested search queries associated with the portion of the search query is determined. Further, it is determined that one of the suggested search queries is associated with a person or entity. A social data store comprising social network data is accessed, and it is determined that the person or entity is associated with a set of social network data. This data can include “like” information, as well as, for example, information regarding a relationship between the user and the person or entity. The set of social network data is presented to the user along with the suggested search query. The combination of the suggested search query and the social network data may help guide the user in selecting an appropriate suggested search query. In one aspect, the set of social network data is used to determine a ranking order of the list of suggested search queries.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system for using social network data to disambiguate at least a portion of a search query suitable for use in implementing embodiments of the present invention;

FIG. 3 depicts a flow diagram that illustrates a method of using social network data to disambiguate at least a portion of a search query and determine a ranking order of a suggested search query in accordance with an embodiment of the present invention;

FIG. 4 depicts a flow diagram that illustrates a method of adding “like” data to search suggestions in accordance with an embodiment of the present invention; and

FIG. 5 depicts an exemplary user interface illustrating a suggested query in association with social network data in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to systems, methods, and computer-readable storage media for, among other things, leveraging the wealth of social network data that exists to help disambiguate search queries. In brief and at a high level, a list of suggested search queries are generated in response to receiving a portion of a search query from a user. Suggested search queries corresponding to a person or entity are checked for potential social network data gathered from the user's online social network and other social networking sites. If a suggested search query has an associated set of social network data, the suggested search query is presented alongside the set of social network data. The social network data includes, for example, relationships between the user and the person or entity, a number of mutual friends between the user and the person or entity, and “like” data associated with the person or entity.

Accordingly, in one embodiment, the present invention is directed to computer-readable storage media having computer-executable instructions embodied thereon that, when executed, facilitate a method of using social network data to disambiguate at least a portion of a search query. The at least a portion of the search query is received from a user while the user is logged on to an online social network. A list of suggested search queries related to the at least a portion of the search query is determined, and a first suggested search query in the list of suggested search queries is determined to be associated with a person or entity. A social data store associated with the online social network is accessed. The social data store comprises social network data. It is determined that the person or entity is associated with a set of social network data, and the set of social network data in connection with the first suggested query is provided to a search engine page.

In another embodiment, the present invention is directed to computer-readable storage media having computer-executable instructions embodied thereon that, when executed, facilitate a method of adding “like” data to search suggestions. At least a portion of a search query is received from a user, and a set of suggested search queries corresponding to the at least a portion of the search query is generated. It is determined that a first suggested search query in the set of suggested search queries is associated with a first entity. A social data store is accessed; the social data store comprises “like” data from a plurality of social networking sites. It is determined that the first entity is associated with a first set of “like” data. The first suggested search query and the first set of “like” data is provided to a search engine page simultaneously with the set of suggested search queries.

In yet another embodiment, the present invention is directed to computer-readable storage media having computer-executable instructions embodied thereon that, when executed, facilitate a method of using social network data to determine a ranking order of a suggested search query. At least a portion of a search query is received, and a set of suggested search queries corresponding to the at least a portion of the search query is determined. It is also determined that at least one suggested search query of the set of suggested search queries is associated with a person or entity. A social data store is accessed, and it is determined that the person or entity is associated with a set of social network data in the social data store. The set of social network data is displayed simultaneously with the at least one suggested search query on a search engine page. Further, a ranking order of the at least one suggested search query is determined by the set of social network data.

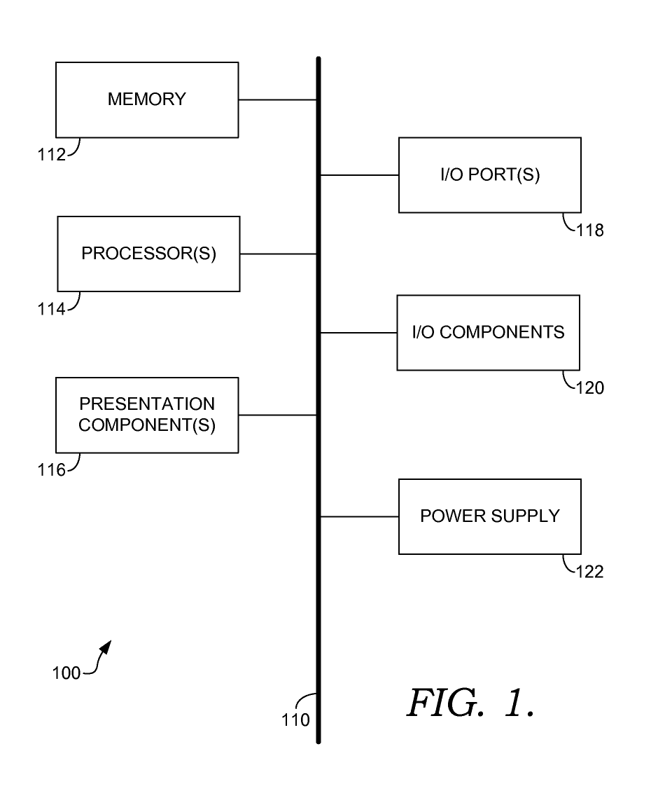

An exemplary computing environment suitable for use in implementing embodiments of the present invention is described below in order to provide a general context for various aspects of the present invention. Referring to FIG. 1, such an exemplary computing environment is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules, including routines, programs, objects, components, data structures, etc., refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, etc.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term “server” is often used herein, it will be recognized that this term may also encompass a search engine, a set of one or more processes distributed on one or more computers, one or more stand-alone storage devices, a set of one or more other computing or storage devices, a combination of one or more of the above, and the like.

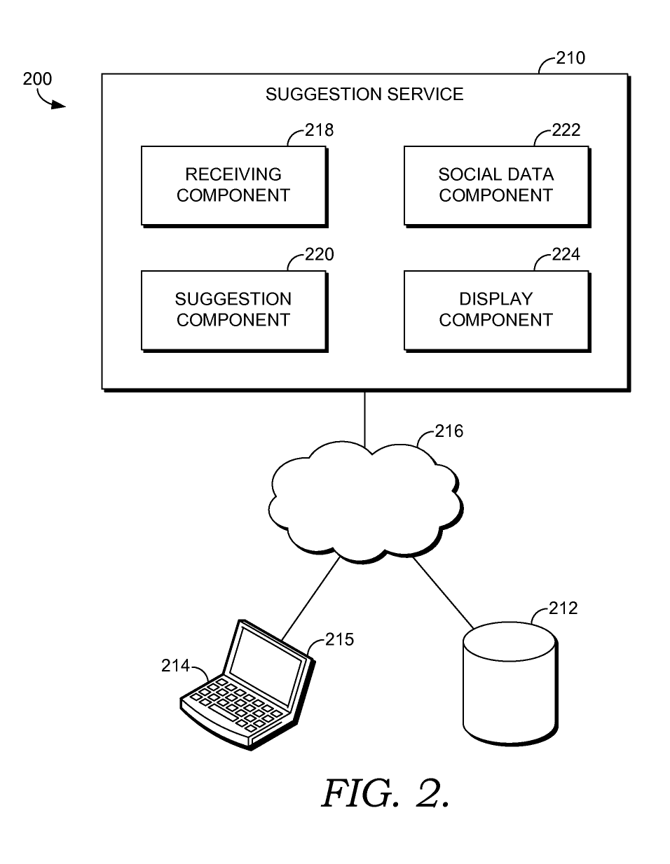

With this as a background and turning to FIG. 2, an exemplary computing environment 200 is depicted for use in adding social network data to search suggestions. The computing system environment 200 is merely an example of one suitable computing system environment and is not intended to suggest any limitation as to the scope of use or functionality of embodiments of the present invention. Neither should the computing system environment 200 be interpreted as having any dependency or requirement related to any single module/component or combination of modules/components illustrated therein.

The computing system environment 200 includes a suggestion service 210, a social data store 212, and an end-user computing device 214 all in communication with one another via a network 216. The network 216 may include, without limitation, one or more local area networks (LANs) and/or wide area networks (WANs). Such networking environments are commonplace in offices, enterprise-wide computer networks, intranets and the Internet. Accordingly, the network 216 is not further described herein.

In some embodiments, one or more of the illustrated components/modules may be implemented as stand-alone applications. In other embodiments, one or more of the illustrated components/modules may be integrated directly into, for example, the operating system of the end-user computing device 214 or the suggestion service 210. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, the suggestion service 210 might reside on a server, cluster of servers, or a computing device remote from one or more of the remaining components. Further, the suggestion service 210 may be associated with a search engine provider.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The social data store 212 is configured to store information for use by, for example, the suggestion service 210. The information stored in association with the social data store 212 is configured to be searchable for one or more of the items of information stored in association therewith. The information stored in association with the social data store 212 may comprise general information used by the suggestion service 210. For example, possible search suggestions associated with a query may be stored as well as search results corresponding to the possible search suggestions. Continuing, information regarding uniform resource locators (URLs) and keywords corresponding to the possible suggestions may be stored along with information such as user clicks on the URLs. As well, the information stored in association with the social data store 212 may comprise social network data. The social network data comprises social network data associated with a user's online social network as well as social network data from a plurality of different social networking sites other than the user's online social network.

For example, social network data associated with the user's online social network may include data indicating: a relationship between the user and a person or entity, a number of mutual friends between the user and the person or entity, locations or networks associated with the person or entity, “like” data associated with the person or entity, an image of the person or entity, and status information associated with the person or entity. As well, social network data gathered from the plurality of different social networking sites may include “like” data from a multitude of people, not just people in the user's online social network. As used throughout this specification, the term “like” indicates an online appreciation for a person, entity, object, event, location, venue, and the like. The content and volume of such information in the social data store 212 are not intended to limit the scope of embodiments of the present invention in any way. Further, though illustrated as a single, independent component, the social data store 212 may, in fact, be a plurality of storage devices, for instance, a database cluster, portions of which may reside on the suggestion service 210, the end-user computing device 214, and/or any combination thereof.

The end-user computing device 214 shown in FIG. 2 may be any type of computing device, such as, for example, the computing device 100 described above with reference to FIG. 1. By way of example only and not limitation, the end-user computing device 214 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof.

As shown, the end-user computing device 214 includes a display screen 215. The display screen 215 is configured to display information to the user of the end-user computing device 214. For instance, the display screen 215 may display a user interface associated with an online social network as well as a search engine page with a search query box. The display screen 215 may also display a list of suggestions to the user along with social network data, and, additionally, the display screen 215 may display a list of search results.

The computing system environment 200 is merely exemplary. While the suggestion service 210 is illustrated as a single unit, it will be appreciated that the suggestion service 210 is scalable. For example, the suggestion service 210 may in actuality include a plurality of computing devices in communication with one another. Moreover, the social data store 212, or portions thereof, may be included within, for instance, the suggestion service 210 as a computer-storage medium. The single unit depictions are meant for clarity, not to limit the scope of embodiments in any form.

As shown in FIG. 2, the suggestion service 210 comprises a receiving component 218, a suggestion component 220, a social data component 222, and a displaying component 224. In some embodiments, one or more of the components 218, 220, 222, and 224 may be implemented as stand-alone applications. In other embodiments, one or more of the components 218, 220, 222, and 224 may be integrated directly into the operating system of a computing device such as the computing device 100 of FIG. 1. It will be understood that the components 218, 220, 222, and 224 illustrated in FIG. 2 are exemplary in nature and in number and should not be construed as limiting. Any number of components may be employed to achieve the desired functionality within the scope of embodiments hereof.

The receiving component 218 is configured to receive (via the network 216) at least a portion of a search query from a user (for example, the user of the end-user computing device 214). The portion of the search query received by the receiving component 218 may comprise a prefix to a search query, one word of a search query, or a whole search query. In one aspect, the portion of the search query may be received while the user is logged on to an online social network such as Facebook® or LinkedIn®.

The suggestion component 220 is configured to generate or determine a list of suggested search queries associated with the at least a portion of the search query. By way of example, if a user begins to type the query, “Bamboo,” the suggestion component 220 may determine a list of suggested search queries comprising: “Bamboo plant,” “Bamboo location,” “Bamboo Garden Restaurant,” and the like. As can be seen, each of the suggested search queries corresponds to the portion of the search query in some way. The list of possible suggested search queries may be stored in, for example, the social data store 212.

The social data component 222 is configured to do a number of things. For instance, the social data component 222 is configured to determine if one of the suggested search queries is related to a person or entity. As used throughout this specification, the term entity comprises an object, person, venue, location, event, and the like. Using the example given above, the social data component 222 may determine that the suggested search query, “Bamboo Garden Restaurant” is an entity. Or, using another example, a user may enter the query, “Chris.” The suggestion component 220 returns a suggested search query of “Chris Daughtry,” and the social data component 222 determines that the suggested search query “Chris Daughtry” corresponds to a person. The social data component 222 may determine that any number of the suggested search queries is associated with any number of persons or entities.

The social data component 222 is also configured to access, for example, the social data store 212. As mentioned above, the social data store 212 may comprise social network data from the user's online social network as well as social network data from multiple different social networking sites. In one aspect, the social data component 222 is able to access social network data from the user's online social network if the user is currently logged on to the online social network.

Once the social data component 222 has accessed the social data store 212, the social data component 222 is configured to determine whether the person or entity corresponding to a suggested search query is associated with a set of social network data. With respect to the user's online social network, the social data component 222 may determine that a set of social network data is present that indicates: a relationship between the user and the person or entity, a number of mutual friends between the user and the person or entity, locations or networks associated with the person or entity, an image of the person or entity, “like” data associated with the person or entity, or status information associated with the person or entity. The “like” data may be from any user of the online social network, or it may be from people that have a defined “friend” relationship with the user on the online social network.

If the user is not currently logged on to the user's online social network, the social data component 222 is still able to access social network data gathered from a plurality of different social networking sites. Although this data is not as specific to the user as the social network data from the user's online social network, it can be used to determine “like” data associated with the suggested search query that corresponds to a person or entity. For example, the social data component 222 is configured to determine that the suggested search query has historically been associated with user clicks on a URL corresponding to the suggested search query. Using the “Bamboo” example, a possible suggested search query is “Bamboo Garden Restaurant.” This suggested search query corresponds to an entity (a restaurant). The social data component 222 accesses historical logs in the social data store 212 to determine if, in the past, the suggested search query, “Bamboo Garden Restaurant,” has led to clicks on the URL “Bamboogardenrestaurant.com.” This type of “suggested search query-URL click history” association provides an indication of whether users have “liked” the suggested search query “Bamboo Garden Restaurant.”

Continuing, another way the social data component 222 determines “like” data associated with a suggested search query is by determining if, in the past, the suggested search query (for example “Bamboo Garden Restaurant”) has led to search results that have contained the URL, “Bamboogardenrestaurant.com.” Additionally, the social data component 222 is able to determine “like” data associated with a suggested search query by determining whether, in theory, the suggested search query could return a URL that represents or is related to the person or entity associated with the suggested search query. Again using the example above, the URL, “Bamboogardenrestaurant.com,” may be associated with one or more keywords such as “That Food,” or “Ethnic Restaurant.” These keywords are related to the suggested search query “Bamboo Garden Restaurant.” Thus, using these keywords, it is possible that the suggested search query could return the URL, “Bamboogardenrestaurant.com.” Although this method is more peripheral compared to the other two methods, it can still provide an indication of “like” data for the suggested search query.

In one aspect of the invention, a suggested search query may be associated with more than one person or entity. For example, the suggested search query, “Santa Maria,” may be associated with a ship name, a restaurant, and a historical figure. The social data component 222 is configured to gather “like” data for all three of these entities using the methods outlined above. Further, the social data component 222 is configured to aggregate the “like” data for these three entities to create an aggregated set of “like” data for the suggested search query, “Santa Maria.” The “like” data may be aggregated by, for example, summing the different sets of “like” data, or weighting the different sets of “like” data based on, for example, a number of user clicks on a URL associated with each entity (the ship, the restaurant, and the historical figure). The weighted sets of “like” data can then be summed.

In yet another aspect of the invention, while the user is logged on to the user's online social network, the social data component 222 determines a set of “like” data for a suggested search query comprising “like” data originating from one or more of the user's online social network friends (a friend set of “like” data). Additionally, the social data component 222 determines another set of “like” data originating from a plurality of different social networking sites using the methods outlined above. The social data component 222 may combine the friend set of “like” data with the set of “like” data originating from the plurality of different social networking sites. Or the social data component 222 may keep these two sets of “like” data separate. Any and all such variations are within the scope of embodiments of the present invention.

Continuing on with respect to FIG. 2, the display component 224 is configured to provide the set of social network data in association with the suggested search query to a search engine page. The display component 224 is also configured to provide the list of suggested search queries to the search engine page regardless of whether the suggested search queries in the list of suggested search queries are associated with social network data. Further, the display component 224 is configured to display the set of social network data in association with the suggested search query. The display component 224 is also configured to display the set of social network data in association with the suggested search query simultaneously with the list of suggested search queries.

The set of social network data in association with the suggested search query may be displayed differently than the list of suggested search queries. For example, it may be set off in a different viewing area of the search engine page. It may be highlighted, bolded, shown with an image, displayed in a different font, or displayed in any other way of emphasizing text or images known in the art.

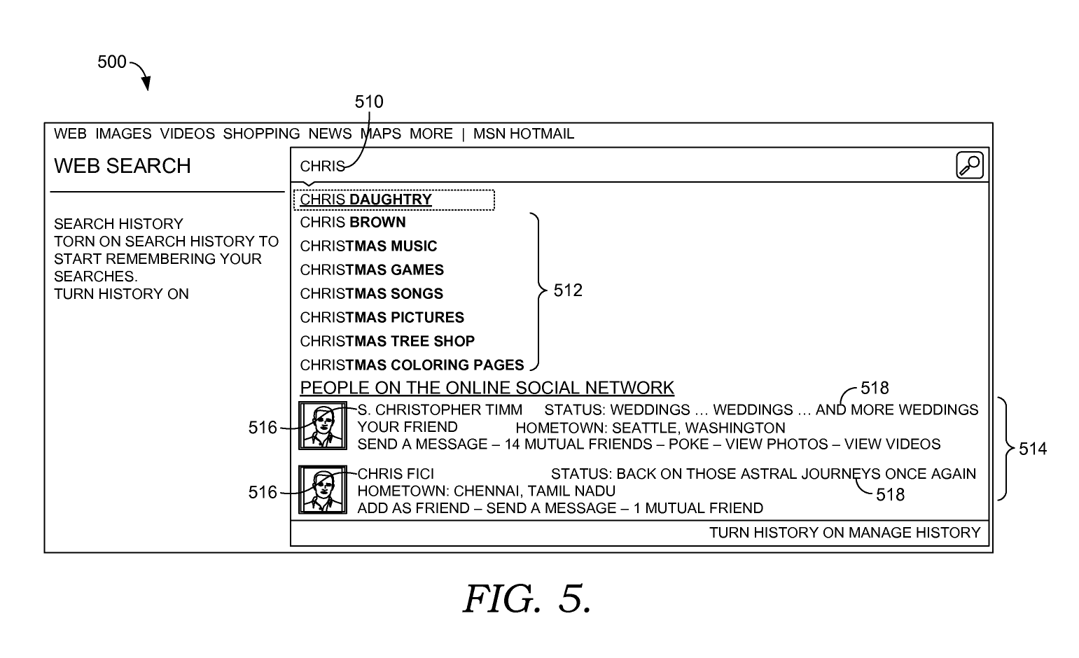

FIG. 5 is an exemplary user interface corresponding to a search engine page and is referenced generally by the numeral 500. The user interface 500 may be generated by, for example, the display component 224 of FIG. 2. FIG. 5 illustrates a search query box 510 in which a user enters a portion of a search query. A list of suggested search queries 512 is shown. The list of suggested search queries 512 is not associated with social network data. Additionally, the user interface 500 depicts an area 514 displaying suggested search queries in association with social network data. This information may be displayed while the user is logged on to the user's online social network. With respect to the area 514, a suggested search query 516 is shown—for example, “S. Christopher Timm,” or “Chris Fici”—in association with a set of social network data 518. This data 518 includes location information, status information, relationship information, and mutual friend information.

When displaying “like” data in association with a suggested search query, the display component 224 is configured to display the friend set of “like” data differently than the set of “like” data originating from the plurality of different social networking sites so that the user can better distinguish between the two. For example, the display component 224 may display “Bamboo Garden Restaurant—22 of your friends liked this and 2000 other people liked this.” The display component 224 may also display one combined set of “like” data that includes the friend set of “like” data and the set of “like” data originating from the plurality of different social networking sites. Any and all such variations are within the scope of the invention.

The display component 224 is also configured to determine a ranking order of the list of suggestions based on the social network data. A suggested search query that is associated with a set of social network data may be ranked higher in the list of suggested search queries than a suggested search query that is not associated with social network data. Additionally, a suggested search query that is associated with a larger set of social network data (for example, an aggregated set of social network data) may be ranked higher than a suggested search query that is associated with a smaller set of social network data. Using social network data to influence a ranking order of a list of suggestions may ultimately lead to improved matching against Web documents.

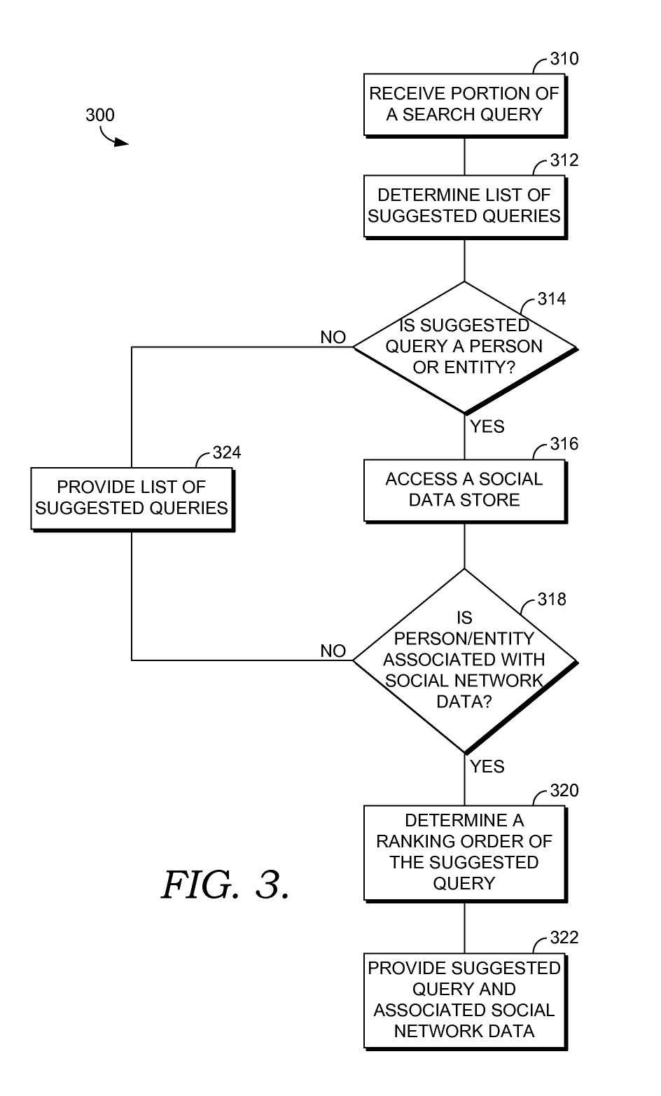

Turning now to FIG. 3, a flow diagram is depicted illustrating a method of using social network data to disambiguate at least a portion of a search query and to determine a ranking order of a suggested search query. The flow diagram is referenced generally by the numeral 300. At step 310, a portion of a search query is received by, for example, a receiving component such as the receiving component 218 of FIG. 2. The portion of the search query may comprise a prefix to a search query, one word of a search query, or the whole search query. At step 312, a list of suggested search queries is determined. This may be done by, for example, a suggestion component (for example, the suggestion component 220 of FIG. 2) accessing a social data store to determine a list of suggestions that are related to the at least a portion of the search query.

At step 314, a determination is made whether any suggested search queries in the list of suggested search queries is associated with a person or entity. This may be done, for example, by accessing a data store such as the social data store 212 of FIG. 2, and comparing the list of suggested search queries with people or entities having that have associated Internet data (URLs corresponding to the person or entity, search results corresponding to the person or entity, Web pages associated with the person or entity, social network data associated with the person or entity, and the like).

If a suggested search query is associated with a person or entity then, at step 316, a social data store is accessed. The social data store comprises, among other things, search engine logs dealing with user responses to various search results, search results associated with the selection of suggested search queries, social network data from the user's online social network, social network data from a plurality of social networking sites, and the like. In one aspect, social network data from the user's online social network may only be accessed if the user is currently logged on to the online social network.

At step 318, a determination is made whether the person or entity corresponding to the suggested search query is associated with a set of social network data. The set of social network data may include the following: “like” data, a relationship between the user and the person or entity, a number of mutual friends between the user and the person or entity, locations or networks associated with the person or entity, an image of the person or entity, and status information associated with the person or entity.

If the person or entity corresponding to the suggested search query is associated with a set of social network data then, at step 320, a ranking order of the suggested search query is determined. For example, a suggested search query that has an associated set of social network data may be ranked higher in the list of suggested search queries than suggested search queries that do not have associated social network data. As well, if a first suggested search query is associated with a larger set of social network data as compared to a second suggested search query, then the first suggested search query may be ranked higher than the second suggested search query. Additionally, the type of social network data associated with a suggested search query may influence a ranking order of the suggested search query. For example, social network data gathered from the user's online social network may have more relevance to the user as compared to social network data from different social networking sites. Suggested search queries associated with this type of social network data may be ranked higher than suggested search queries associated with the more general type of social network data.

At step 322, the suggested search query and its associated set of social network data is provided to a search engine page and displayed to the user. The suggested search query and its associated set of social network data may be displayed simultaneously with the list of suggested search queries that are not associated with social network data. Further, the suggested search query and its associated set of social network data may be displayed differently than the list of suggested search queries so as to draw the user's attention to the query.

If at step 314, it is determined that none of the suggested search queries in the list of suggested search queries are associated with a person or entity, then, at step 324, the list of suggested search queries is provided to the user. As well, if it is determined at step 318 that the person or entity associated with a suggested search query does not have an associated set of social network data, the suggested search query is provided to the user at step 324 along with the list of suggested search queries.

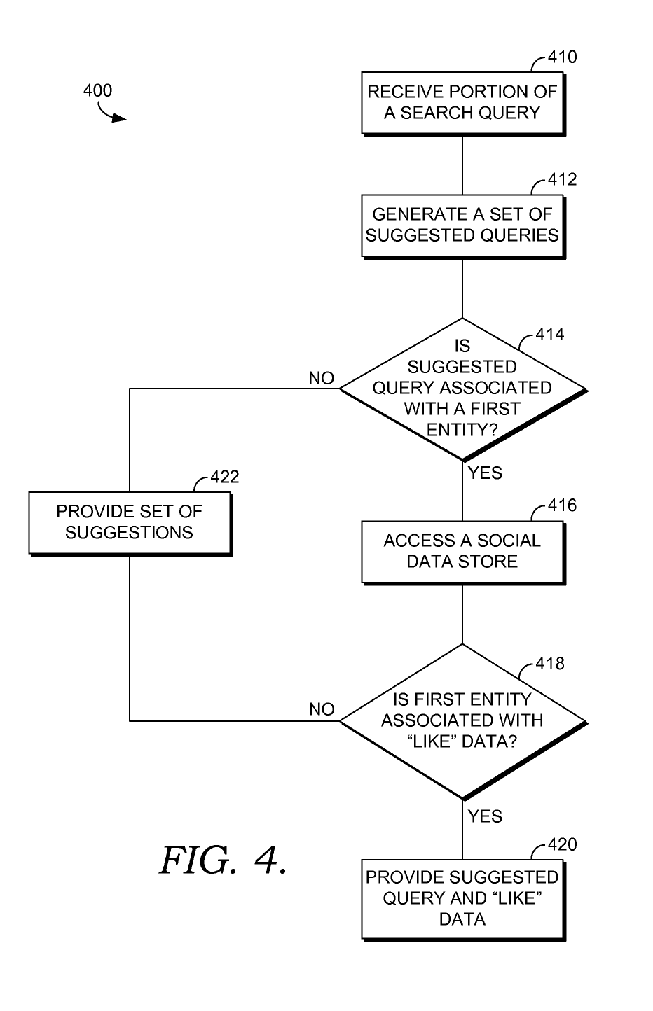

Turning now to FIG. 4, a flow diagram is depicted illustrating a method of adding “like” data to suggested search queries and is referenced generally by the numeral 400. At step 410, at least a portion of a search query is received from a user, and at step 412, a set of suggested search queries is generated. At step 414, it is determined whether at least one of the suggested queries in the set of suggested search queries is associated with a first entity. The first entity may be a person, object, location, venue, event, or the like.

If a suggested search query is associated with a first entity then, at step 416, a social data store is accessed. The social data store may comprise “like” information from the user's online social network in addition to “like” data from a plurality of different social networking sites. “Like” information from the user's online social network may, in one aspect, include “like” information from all users enrolled in the user's online social network. Alternatively, the “like” information from the user's online social network may include just the “like” information from the user's online social network friends.

At step 418, it is determined whether the first entity is associated with a set of “like” data. This may be determined by, for example, a social data component such as the social data component 222 of FIG. 2. The first entity may be associated with “like” data if, for example, one of the user's online friends indicated that he or she “liked” the first entity using a selectable “like” option on a Web page. Another way that users may indicate that they “liked” the first entity includes determining whether the users have clicked on a URL associated with the first entity. An additional way to determine whether the first entity is associated with “like” data includes accessing search results associated with the selection of the suggested search query to determine if the first entity has historically been associated with a display of the URL corresponding to the first entity on a search engine page. Further, it may be determined that the first entity has historically been associated with one or more keywords associated with the URL corresponding to the first entity. This gives another indication of “like” data.

If the first entity is associated with “like” data then, at step 420, the suggested search query corresponding to the first entity is provided in association with the “like” data for the suggested search query. The suggested search query and the associated “like” data may be provided and displayed simultaneously with the set of suggested search queries on a search engine page. As well, the suggested search query and the associated “like” data may be displayed differently than the set of suggested search queries to draw the user's attention to the query. Still further, the associated “like” data may be split into “like” data from the user's online social network friends and “like” data gathered from the plurality of different social networking sites.

If, at step 414, it is determined that none of the suggested search queries in the set of suggested search queries is associated with an entity, then, at step 422, the set of suggested search queries is provided to the user. Likewise, if, at step 418, it is determined that the first entity is not associated with a set of “like” data, then the suggested search query corresponding to the first entity is provided to the user along with the set of suggested search queries at step 422.

In one aspect of the invention, a suggested search query may be associated with both a first entity and a second entity. In this case, “like” data is determined for both the first entity and the second entity, and the “like” data is aggregated to create an aggregated set of “like” data associated with the suggested search query. Aggregation can occur by summing the “like” data for the first and second entity, weighting the “like” data for the entities and then summing, and the like. Although only two entities are discussed, it is contemplated that more than two entities may be associated with a suggested search query. The aggregated set of “like” data is provided in association with the suggested search query to a search engine page.

The present invention has been described in relation to particular embodiments, which are intended in all respects to be illustrative rather than restrictive. Alternative embodiments will become apparent to those of ordinary skill in the art to which the present invention pertains without departing from its scope.

What is claimed is:

1. One or more computer-readable storage media having computer-executable instructions embodied thereon that, when executed, facilitate a method of using social network data to disambiguate at least a portion of a search query, the method comprising:
receiving the at least a portion of the search query from a user while the user is logged on to an online social network;
determining a list of suggested search queries associated with the at least a portion of the search query;
determining that a first suggested search query in the list of suggested search queries is associated with a person or entity;
accessing a social data store associated with the online social network, the social data store comprising social network data;
determining that the person or entity is associated with a set of social network data in the social data store; and
providing the set of social network data in association with the first suggested search query to a search engine page.

2. The media of claim 1, wherein the entity comprises a venue, object, location, or event.

3. The media of claim 1, wherein the set of social network data comprises data indicating:
(A) a relationship between the user and the person or entity,
(B) a number of mutual friends between the user and the person or entity,
(C) locations or networks associated with the person or entity,
(D) an image of the person or entity, or
(E) status information associated with the person or entity.

4. The media of claim 1, further comprising:
displaying the set of social network data in association with the first suggested search query on the search engine page.

5. The media of claim 4, wherein the set of social network data in association with the first suggested search query is displayed simultaneously with the list of suggested search queries.

6. The media of claim 5, wherein the set of social network data in association with the first suggested search query is displayed differently than the list of suggested search queries.

7. One or more computer-readable storage media having computer-executable instructions embodied thereon that, when executed, facilitate a method of adding “like” data to suggested search queries, the method comprising:
receiving at least a portion of a search query from a user;
generating a set of suggested search queries corresponding to the at least a portion of the search query;
determining that a first suggested search query in the set of suggested search queries is associated with a first entity;
accessing a social data store, the social data store comprising “like” data from a plurality of social networking sites;
determining that the first entity is associated with a first set of “like” data in the social data store; and
providing the first suggested search query and the first set of “like” data to a search engine page simultaneously with the set of suggested search queries.

8. The media of claim 7, wherein the first entity comprises a person, object, location, venue, or event.

9. The media of claim 7, wherein the first set of “like” data comprises data indicating an appreciation for the first entity.

10. The media of claim 7, wherein determining that the first entity is associated with the first set of “like” data comprises:
(A) determining that the first entity has historically been associated with user clicks on a uniform resource locator (URL) corresponding to the first entity,
(B) determining that the first entity has historically been associated with a display of the URL corresponding to the first entity, or
(C) determining that the first entity has historically been associated with one or more keywords associated with the URL corresponding to the first entity.

11. The media of claim 7, wherein the first suggested query comprises a second entity.

12. The media of claim 11, further comprising:
determining that the second entity is associated with a second set of “like” data in the social data store;
creating an aggregated set of “like” data by aggregating the first set of “like” data and the second set of “like” data; and
providing the first suggested search query and the aggregated set of “like” data to the search engine page simultaneously with the set of suggested search queries.

13. The media of claim 12, wherein creating the aggregated set of “like” data comprises at least one of:
(A) summing the first set of “like” data and the second set of “like” data, or
(B) weighting the first set of “like” data and the second set of “like” data according to a number of user clicks on a URL associated with the first entity or the second entity and summing the weighted “like” data.

14. The media of claim 13, wherein the first suggested search query is ranked higher than the set of suggested search queries based on the aggregated set of “like” data.

15. The media of claim 7, wherein the user is logged on to an online social network.

16. The media of claim 15, further comprising:
determining that the first entity is associated with a friend set of “like” data, the friend set of “like” data comprising “like” data originating from one or more online social network friends of the user; and
providing the first suggested search query, the first set of “like” data and the friend set of “like” data to the search engine page simultaneously with the set of suggested search queries.

17. The media of claim 16, further comprising:
displaying the first suggested search query, the first set of “like” data, the friend set of “like” data, and the set of suggested search queries on the search engine page.

18. The media of claim 17, wherein the friend set of “like” data is displayed differently from the first set of “like” data.

19. One or more computer-readable storage media having computer-executable instructions embodied thereon that, when executed, facilitate a method of using social network data to determine a ranking order of a suggested search query, the method comprising:
receiving at least a portion of a search query;
determining a set of suggested search queries corresponding to the at least a portion of the search query;
determining that at least one suggested search query of the set of suggested search queries is associated with a person or entity;
accessing a social data store;
incident to accessing the social data store, determining that the person or entity is associated with a set of social network data in the social data store; and
simultaneously displaying the set of social network data in association with the at least one suggested search query on a search engine page, a ranking order of the at least one suggested search query being determined by the set of social network data.

20. The media of claim 19, wherein the set of social network data comprises data indicating:
(A) “like” data,
(B) a relationship between the user and the person or entity,
(C) a number of mutual friends between the user and the person or entity,
(D) locations or networks associated with the person or entity,
(E) an image of the person or entity, and
(F) status information associated with the person or entity.
